(19) United States
(12) Patent Application Publication
(10) Pub. No.: US 2006/0036900 A1
(43) Pub. Date: Feb. 16, 2006

(54) Communication system that reduces the amount of time required to switch over from an active access card to a standby access card

(76) Inventors: Paul Edwin O'Connor, Grass Valley, CA (US); Paul Brian Ripy, Guerneville, CA (US); Keith Q. Chung, Durham, NC (US); Christophe Pierre Leroy, Rohnert Park, CA (US)

Correspondence Address: LAW OFFICES OF MARK C. PICKERING, P.O. BOX 300, PETALUMA, CA, 94953, US

(21) Appl. No.: 10/759,479

(22) Filed: Jan. 16, 2004

(51) Int. Cl. G06F 11/00

(52) U.S. Cl. 714/6

(57) ABSTRACT

An input memory circuit, which has a plurality of addresses that have an associated plurality of keys, forwarding information, and enable/disable flags, receives a plurality of input cells, extracts key information from each input cell, compares the key information from each input cell with the keys, and outputs forwarding information for an input cell when the key information of the input cell matches a key at an address and the address is enabled.

### BACKGROUND OF THE INVENTION

1. Field of the Invention

The present invention relates to a communication system and, more particularly, to a communication system that reduces the amount of time required to switch over from an active access card to a standby access card after the active access card has failed.

2. Description of the Related Art

A communication system is a system that connects together a number of communication circuits to exchange signals between each other. For example, a user, an access system, and a data network, such as the internet, can be part of a communication system that passes information between the user and the data network.

FIG. 1 shows a block diagram that illustrates a prior art communication system 100. As shown in FIG. 1, communication system 100 includes a user 110, an access system 112 that is connected to user 110, and a data network 114, such as an ATM network, that is connected to access system 112.

Access system 112, in turn, includes an active access card 120 and a standby access card 122 that are both connected to user 110. Although only a single user is shown, a number of users, such as six users, can be connected to the same active and standby access cards 120 and 122.

Further, access system 112 includes a global control card 124, and a bus 126 that is connected to data network 114, access cards 120 and 122, and global control card 124. Global control card 124 loads and monitors the operation of cards 120 and 122, and controls the operation of bus 126. (A number of active and standby cards, which are connected to additional users, can also be connected to bus 126.)

In access system 112, the active and standby access cards 120 and 122 are identical except for the information that is stored on the cards in a volatile memory. Active access card 120 has an input (to the user) memory circuit 130A that includes a binary table, and an input (to the user) routing circuit 132A that is connected to receive signals from the binary table of memory circuit 130A. Similarly, standby access card has an input (to the user) memory circuit 130B that includes a binary table, and an input (to the user) routing circuit 132B that is connected to receive signals from the binary table of memory circuit 130B.

In addition, access card 120 has an output (to the network) memory circuit 134A that includes a binary table, and an output (to the network) routing circuit 136A that is connected to receive signals from the binary table in memory circuit 134A. Similarly, standby card 122 has an output (to the network) memory circuit 134B that includes a binary table, and an output (to the network) routing circuit 136B that is connected to receive signals from the binary table in memory circuit 134B.

Further, access card 120 has a local controller 140A that is connected to the binary tables in memory circuits 130A and 134A. Local controller 140A, which can be independently addressed over bus 126, controls the operation of card 120, monitors the connection to user 110, and controls the information that is written into the binary tables in memory circuits 130A and 134A. Local controller 140A includes processing logic and a microprocessor.

Similarly, standby card 122 has a local controller 140B that is connected to the binary tables in memory circuits 130B and 134B. Local controller 140B, which can be independently addressed over bus 126, controls the operation of card 122, monitors the connection to user 110, and controls the information that is written into the binary tables in memory circuits 130B and 134B. Local controller 140B also includes processing logic and a microprocessor.

TABLE 1 illustrates the binary table of active input memory circuit 130A. As shown in TABLE 1, the binary table has three columns and a number of rows. The three columns include a physical address column, a key column, and a routing information column.

TABLE 1

| Physical Address | Key | Routing Information |
|---|---|---|
| N | 1111 1111 ... 1111 | Invalid Route |
| | ... | |
| | 1111 1111 ... 1111 | Invalid Route |
| N/2 + 2 | 1001 0010 ... 1000 | Valid Control Route |
| N/2 + 1 | 1001 0010 ... 0100 | Valid Data Route |
| N/2 | 1001 0010 ... 0010 | Valid Control Route |
| N/2 − 1 | 1001 0010 ... 0000 | Valid Data Route |
| | 0000 0000 ... 0000 | Invalid Route |
| 0000 0000 ... 0001 | ... | |
| 0000 0000 ... 0000 | 0000 0000 ... 0000 | Invalid Route |

The physical address column identifies a sequential list of the addresses used by the binary table, while the key column identifies keys that are associated with the addresses. The keys match header information associated with an ATM cell, such as the Virtual Connection Indicator (VCI) and the Virtual Path Indicator (VPI) of the ATM cell, or a combination of the port number and the header information (VCI/VPI) of the ATM cell.

The routing information column identifies forwarding information that is associated with each key, and includes an invalid route, a valid data route, and a valid control route. An invalid route is forwarding information that a routing circuit either does not recognize or recognizes as a blocking command.

A valid data route is forwarding information that is recognized by the routing circuit, and provides the information necessary to forward a cell on to a data destination, such as user 110. A valid control route, on the other hand, is forwarding information that is recognized by the routing circuit, and provides the information necessary to forward a cell on to a control destination, such as global control card 124 or local controller 140A.

As further shown in TABLE 1, the empty rows in the lower half of the table are filled with zeros, and the empty rows in the upper half of the table are filled with ones. In addition, the filled rows are ordered and centered. In other words, if the memory is not full, the first entry is located at the median address (N/2) minus X, and the last entry is located at the median address (N/2) plus X, where 2X equals the total number of rows with entries in the binary table. In addition, an entry at a location Y is always inferior in value to the entry at a location Y+1.

TABLE 2 illustrates the binary table of standby input memory circuit 130B. As shown, TABLE 2 is a mirror of TABLE 1 except that all of the data routes in the routing information column are to invalid routes. In addition, some of the keys and the valid control routes are different such that the forwarding information is information that is recognized by the routing circuit, and necessary to forward a cell on to a control destination, such as global control card 124 or local controller 140B.

TABLE 2

| Physical Address | Key | Routing Information |
|---|---|---|
| N | 1111 1111 ... 1111 | Invalid Route |
| | ... | |
| | 1111 1111 ... 1111 | Invalid Route |
| N/2 + 2 | 1001 0010 ... 1100 | Valid Control Route |
| N/2 + 1 | 1001 0010 ... 0100 | Invalid Route |
| N/2 | 1001 0010 ... 00110 | Valid Control Route |
| N/2 − 1 | 1001 0010 ... 0000 | Invalid Route |
| | 0000 0000 ... 0000 | Invalid Route |
| 0000 0000 ... 0001 | ... | |
| 0000 0000 ... 0000 | 0000 0000 ... 0000 | Invalid Route |

Operation begins with startup. During startup, global control card 124 addresses local controller 140A over bus 126 and writes the control 10 routes (the keys and forwarding information) to local controller 140A on active access card 120. Local controller 140A, in turn, writes the control routes to the binary tables in memories 130A and 134A on active access card 120.

Following this, global control card 124 addresses local controller 140B over bus 126 and writes the control routes to local controller 140B on standby access card 122. Local controller 140B, in turn, writes the control routes to the binary tables in memory circuits 130B and 134B on standby access card 122.

Once the control routes have been added, global control card 124 addresses local controller 140A over bus 126, and writes the data routes (the keys and forwarding information) with valid routing information to local controller 140A on active access card 120. Local controller 140A, in turn, writes the data routes to the binary tables in memories 130A and 134A as valid data routes.

Following this, global control card 124 addresses local controller 140B over bus 126 and writes the data routes with invalid routing information (invalid routes) to local controller 140B on standby access card 122. Local controller 140B, in turn, writes the data routes with invalid forwarding information (invalid routes) to the binary tables in memories 130B and 134B on standby access card 122.

During normal operation, active input memory circuit 130A receives a series of ATM cells from data network 114, extracts key information, such as the VCI and VPI, from each ATM cell, and compares the key information from each ATM cell with the keys in the key column of the binary table in memory circuit 130A. In addition, memory circuit 130A outputs forwarding information that corresponds with the key from the routing information column when the key information of the ATM cell matches a key.

Active input routing circuit 132A also receives the ATM cells from data network 114, and forwarding information from the routing information column of the binary table in memory 130A. In addition, routing circuit 132A transmits an input ATM cell to user 110 in response to the forwarding information for the input ATM cell. If no forwarding information or a predefined forwarding route is received, routing circuit 132A takes no further action, thereby dropping the cell.

In addition, active input memory circuit 130A receives ATM cells from global control card 124. Memory circuit 130A treats these ATM cells the same, extracting key information, comparing the key information from the ATM cell with the keys in the key column, and outputting forwarding information from the routing information column that corresponds with the key when the key information of the ATM cell matches a key.

The forwarding information routes the ATM cell directly back to global control card 124 where global control card 124 interprets the response to indicate a level of activity. For example, by sending out a cell on a periodic basis, such as every one second, and detecting each response from access cards 120 and 122, global control card 124 can monitor access cards 120 and 122 and determine when either of the access cards 120 or 122 has failed. The forwarding information can also forward the cell to local controller 140A, which outputs an ATM cell back to global control card 124 that is responsive to one of a number of status queries.

At the same time, standby input memory circuit 130B also receives the ATM cell from data network 114, and extracts key information, such as the VCI and VPI, from the ATM cell. In addition, memory circuit 130B compares the key information from the ATM cell with the keys in the key column of the binary table in memory circuit 130B, and outputs forwarding information from the routing information column that corresponds with the key when the key information of the ATM cell matches a key.

However, with standby input memory circuit 130B, the nature of the routing information depends on whether the ATM cell is a control cell or a data cell. If the cell is a control cell, which is forwarded to global control card 124 or local controller 140B, the routing information is valid. If the cell is a data cell, which is forwarded to user 110, the routing information is invalid.

As a result, when standby input routing circuit 132B receives an ATM cell destined for user 110, the ATM cell is dropped due to the invalid routing information. However, when standby input routing circuit 132B receives an ATM cell destined for global control card 124 or local controller 140B, circuit 132B transmits the ATM cell in response to the forwarding information for the ATM cell. Thus, as long as active access card 120 is functioning properly, only active access card 120 forwards data cells to user 110.

ATM cells output by user 110 are handled in the same fashion. User 110 outputs an ATM cell that is received by active output memory circuit 134A. As above, circuit 134A extracts key information, such as the VCI and VPI, from the ATM cell. In addition, memory circuit 134A compares the key information from the ATM cell with the keys in the key column of the binary table in memory circuit 134A, and outputs forwarding information from the routing information column that corresponds with the key when the key information of the ATM cell matches a key.

Active output routing circuit 136A also receives the ATM cell from user 110, along with forwarding information from the routing information column of the binary table in memory 134A, and transmits the ATM cell in response to the forwarding information for the ATM cell. Memory circuit 134B and output routing circuit 136B, in turn, operate in the same manner as memory circuit 130B and output routing circuit 132B.

When active access card 120 fails, global control card 124 detects the condition, and proceeds to shift control over to standby access card 122, which now becomes the new active access card. Control proceeds by first determining the data keys that are present in the active and standby access cards 120 and 122. The data keys are keys which have associated routing information that forwards the ATM cell to a data destination, such as user 110.

Following this, for each data key, a search algorithm is executed that finds the data key in the binary table of memory circuit 130A of access card 120, and returns the corresponding physical address of the data key. Next, for each data key, an invalid route is written into the routing information column at the corresponding physical address in the binary table of access card 120.

In addition, for each data key, the search algorithm is again executed to find the data key in the binary table of memory circuit 130B of new active access card 122, and returns the corresponding physical address of the data key. Next, for each data key, a valid data route that corresponds with the data key is written into the routing information column at the corresponding physical address in the binary table of the new active access card 122.

Once this process has been completed, the old standby access card has been transformed into the new active access card 122 by writing invalid data routes into access card 120 to make card 120 look like old card 122, and writing valid data routes into access card 122 to make card 122 look like old card 120.

One drawback of this approach is that when the binary tables on access cards 120 and 122 contain large numbers of rows of information, it can take a significant amount of time to write the invalid and valid data routes to switch over to access card 122 after access card 120 has failed. Thus, there is a need for a communication system that reduces the amount of time required to switch over to access card 122 after access card 120 has failed.

### SUMMARY OF THE INVENTION

The present invention provides a communication system that reduces the amount of time required to switch over to a standby access card after an active access card has failed. The communication system of the present invention includes an active input circuit. The active input circuit has an active input memory circuit that has a plurality of addresses which, in turn, have an associated plurality of keys and forwarding information.

The active input memory circuit receives a plurality of cells, extracts key information from each cell, and compares the key information from each cell with the keys. The active input memory circuit outputs forwarding information for a cell when the key information of the cell matches a key.

The communication system also includes an active input routing circuit that is connected to the active input memory circuit. The active input routing circuit receives the plurality of cells, and forwarding information from the active input memory circuit for a number of the cells. The active input routing circuit transmits an input cell onto a bus in response to forwarding information for the input cell.

The present invention also includes a method of operating a circuit that has a plurality of addresses which, in turn, have an associated plurality of keys and forwarding information. The method includes the steps of receiving a plurality of cells, and extracting key information from each cell. The method also includes the steps of comparing the key information from each cell with the keys, and outputting forwarding information for an input cell when the key information of the input cell matches a key.

The present invention additionally includes a method of operating a circuit that has a plurality of addresses which, in turn, have an associated plurality of keys, forwarding information, control/data flags, and enable/disable flags. The method includes the steps of determining whether an enable all command has been received, and when the enable all command has been received, setting the enabled/disabled flags to enabled for each address unless the address has a key that matches a predetermined pattern.

The present invention further includes a method of operating a circuit connected to first and second local controllers via a bus. The method includes the steps of addressing the first local controller over the bus and writing a plurality of control routes to the first local controller, and addressing the second local controller over the bus and writing a plurality of control routes to the second local controller.

In addition, the method includes the steps of addressing the first local controller over the bus and writing a plurality of data routes with valid routing information to the first local controller, and addressing the second local controller over the bus and writing a plurality of data routes with valid routing information to the second local controller.

The method further includes the steps of addressing the first local controller over the bus and writing an enable all command to the first local controller, and addressing the second local controller over the bus and writing an enable control command to the second local controller.

The present invention additionally includes a method of operating a circuit connected to first and second local controllers via a bus. The method includes the steps of detecting a failure condition and, when a failure condition has been detected, outputting a disable data command to the first local controller. In addition, the method includes the step of outputting an enable all command to the second local controller.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a prior art communication system 100.

FIG. 2 is a block diagram illustrating a communication system 200 in accordance with the present invention.

FIG. 3 is a flow chart illustrates a method of operating global control card 124 at startup in accordance with the present invention.

FIG. 4 is a flow chart illustrating a method of operating logic controller 214A in accordance with the present invention.

FIG. 5 is a flow chart illustrating a method of operating memory circuit 210A in accordance with the present invention.

FIG. 6 is a flow chart illustrating a method of operating global control card 124 when a failure has occurred in accordance with the present invention.

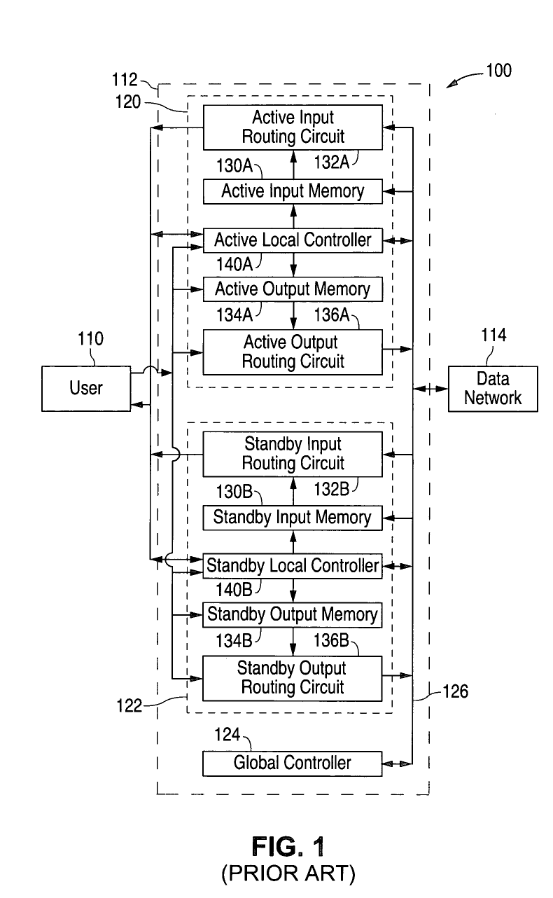

### DETAILED DESCRIPTION OF THE INVENTION

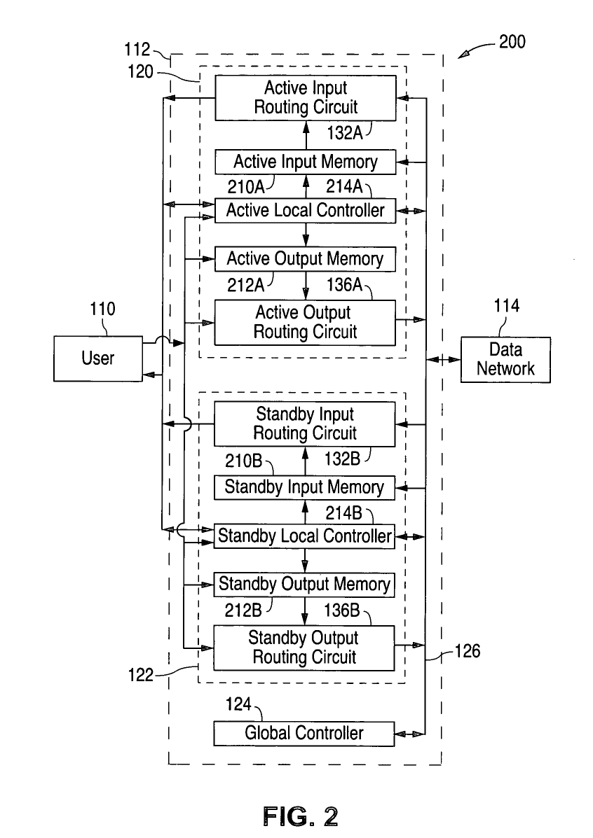

FIG. 2 shows a block diagram that illustrates an example of a communication system 200 in accordance with the present invention. System 200 is similar to system 100 and, therefore, utilizes the same reference numerals to designate the structures which are common to both systems.

As shown in FIG. 2, system 200 differs from system 100 in that access card 120 has an active input memory circuit 210A with a larger binary table. TABLE 3 illustrates the binary table of memory circuit 210A in accordance with the present invention. As shown in TABLE 3, the binary table has five columns and a number of rows.

The five columns include the three columns from TABLE 1 (a physical address column, a key column, and a routing information column), a control/data column that indicates the type of route (data or control), and an enable/disable column that indicates whether the entries at a row in the binary table are valid (enabled) or invalid (disabled).

TABLE 3

| | | Routing | | |
|---|---|---|---|---|
| Physical | | Infor- | Control/ | Enable/ |
| Address | Key | mation | Data | Disable |
| N | 1111 1111 ... 1111 | Invalid | | D |
| | | Route | | |
| | ... | | | |
| | 1111 1111 ... 1111 | Invalid | | D |
| | | Route | | |
| N/2 + 2 | 1001 0010 ... 1000 | Valid | C | E |
| | | Control | | |
| | | Route | | |
| N/2 + 1 | 1001 0010 ... 0100 | Valid | D | E |
| | | Data | | |
| | | Route | | |
| N/2 | 1001 0010 ... 0010 | Valid | C | E |
| | | Control | | |
| | | Route | | |
| N/2 − 1 | 1001 0010 ... 0000 | Valid | D | E |
| | | Data | | |
| | | Route | | |
| | 0000 0000 ... 0000 | Invalid | | D |
| | | Route | | |
| 0000 0000 ... 0001 | ... | | | D |
| 0000 0000 ... 0000 | 0000 0000 ... 0000 | Invalid | | D |
| | | Route | | |

The control/data column indicates whether the route is a data route (to a data destination such as user 110) or a control route (to a control destination such as global control card 124 or local controller 140A). In addition, the enable/disable column indicates whether the corresponding forwarding information is valid (enabled) or invalid (disabled).

As shown in FIG. 2, system 200 further differs from system 100 in that access card 122 has a standby input memory circuit 210B with a larger binary table. TABLE 4 illustrates the binary table of memory circuit 210B in accordance with the present invention.

TABLE 4

| | | Routing | | |
|---|---|---|---|---|
| Physical | | Infor- | Control/ | Enable/ |
| Address | Key | mation | Data | Disable |
| N | 1111 1111 ... 1111 | Invalid | | D |
| | ... | Route | | |
| | 1111 1111 ... 1111 | Invalid | | D |
| | | Route | | |
| N/2 + 2 | 1001 0010 ... 0000 | Valid | C | E |
| | | Control | | |
| | | Route | | |
| N/2 + 1 | 1001 0010 ... 1000 | Valid | D | D |
| | | Data | | |
| | | Route | | |
| N/2 | 1001 0010 ... 1110 | Valid | C | E |
| | | Control | | |
| | | Route | | |
| N/2 − 1 | 1001 0010 ... 1111 | Valid | D | D |
| | | Data | | |
| | | Route | | |
| | 0000 0000 ... 0000 | Invalid | | D |
| | | Route | | |
| 0000 0000 ... 0001 | ... | | | D |
| 0000 0000 ... 0000 | 0000 0000 ... 0000 | Invalid | | D |
| | | Route | | |

As shown, TABLE 4 is a mirror of TABLE 3 except that all of the data routes in the routing information column are valid data routes which have been disabled. Thus, unlike TABLE 2 where the data keys have associated invalid data routes, the data keys in TABLE 4 have corresponding valid data routes. As a result, each address in active input memory circuit 210A that has a control/data flag set to data is enabled, and each address in standby input memory circuit 210B that has a control/data flag set to data is disabled.

In addition, some of the keys and the valid control routes are different such that the forwarding information is information that is recognized by the routing circuit, and necessary to forward a cell on to a control destination, such as global control card 124 or local controller 140B.

As a result, each address in the binary table in active input memory circuit 210A that has a key and a control/data flag set to control is enabled, and each address in the binary table in standby input memory circuit 210B that has a key and a control/data flag set to control is enabled.

As shown in FIG. 2, system 200 further differs from system 100 in that access card 120 has an active output memory circuit 212A with a larger binary table, and a standby output memory circuit 212B with a larger binary table. The binary tables in memory circuits 212A and 212B are the same as the binary tables in circuits 210A and 210B except that memory circuits 212A and 212B store different information for the data and control routes.

In addition, system 200 further differs from system 100 in that access card 120 has an active local controller 214A, while access card 122 has a standby local controller 214B. In the present invention, controllers 214A and 214B both have processing logic, command logic, and a microprocessor.

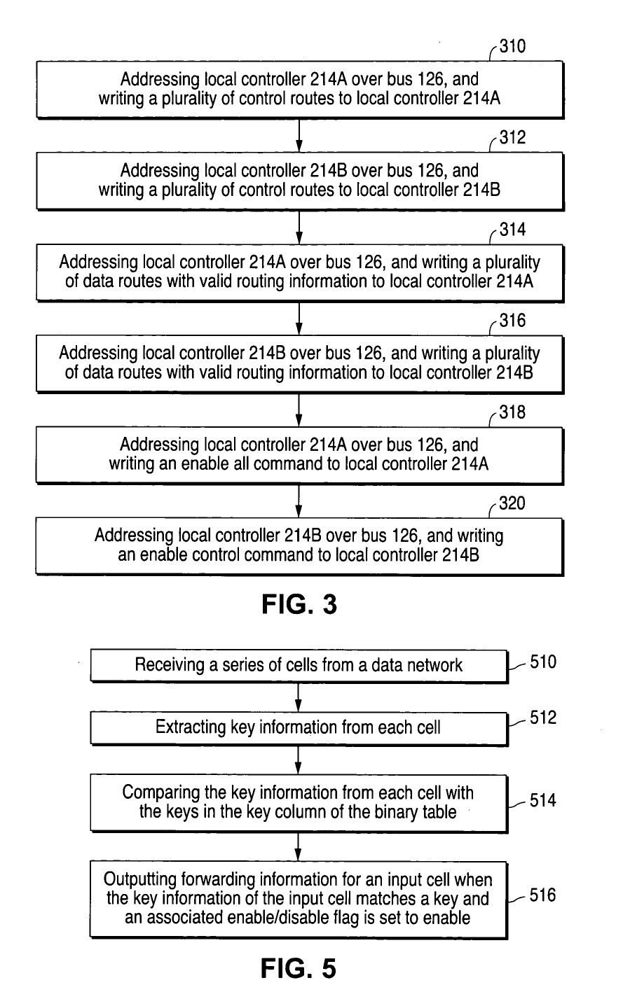

Operation begins with startup. FIG. 3 shows a flow chart that illustrates a method of operating global control card 124 at startup in accordance with the present invention. As shown in FIG. 3, the method begins at step 310 where global control card 124 addresses local controller 214A over bus 126, and writes the control routes (the keys, routing information, control/data flags, and enable/disable flags) to local controller 214A on active access card 120. Local controller 214A, in turn, writes the keys and routing information, sets the control/data flags to control, and the enable/disable flags to disable for the entries in the binary tables in memories 210A and 212A. (The binary tables in memories 210A and 212A receive different entries.)

Following this, the method moves to step 312 where global control card 124 addresses local controller 214B over bus 126, and writes the control routes to local controller 214B on standby access card 122. Local controller 214B, in turn, writes the keys and routing information, sets the control/data flags to control, and the enable/disable flags to disable for the entries in the binary tables in memories 210B and 212B. (The binary tables in memories 210B and 212B receive different entries.)

Once the control routes have been added, the method moves to step 314 where global control card 124 addresses local controller 214A over bus 126, and writes the data routes (the keys, routing information, control/data flags, and enable/disable flags) with valid routing information to local controller 214A on active access card 120. Local controller 214A, in turn, writes the keys and routing information, sets the control/data flags to data, and the enable/disable flags to disable for the entries in the binary tables in memories 210A and 212A.

Following this, the method moves to step 316 where global control card 124 addresses local controller 214B over bus 126, and writes the data routes (the keys, routing information, control/data flags, and enable/disable flags) with valid routing information to local controller 214B on standby access card 122. Local controller 214B, in turn, writes the keys and routing information, sets the control/data flags to data, and the enable/disable flags to disable for the entries in the binary tables in memories 210B and 212B.

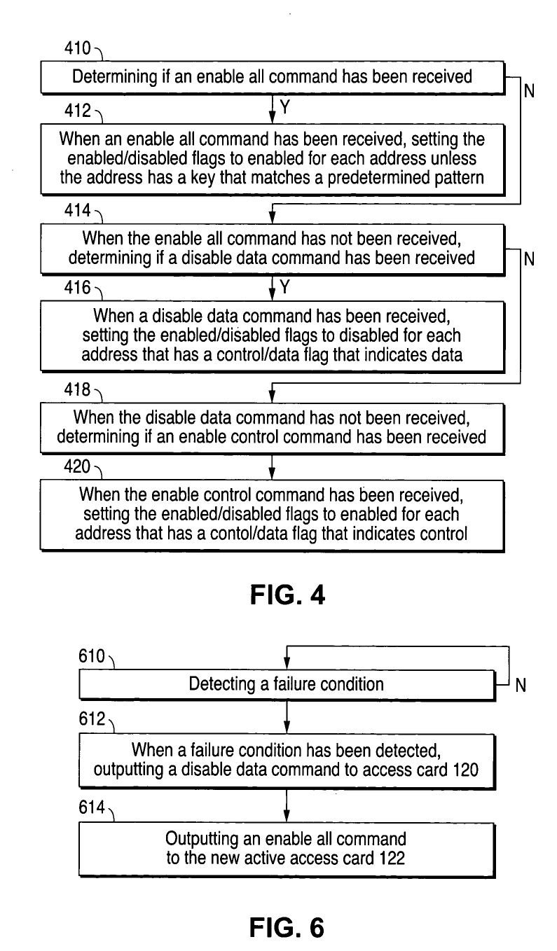

After the data routes have been written to standby access card 122, global control card 124 outputs a number of commands which can be processed by the command logic of the local controller. FIG. 4 shows a flow chart that illustrates a method of operating local controller 214A in accordance with the present invention.

As shown in FIG. 4, the method begins at step 410 by determining if an enable all command has been received. When an enable all command has been received, the method moves to step 412 to set the enabled/disabled flags to enabled for each address unless the address has a key that matches a predetermined pattern.

When the enable all command has not been received, the method moves from step 410 to step 414 to determine if a disable data command has been received. When a disable data command has been received, the method moves to step 416 to set the enabled/disabled flags to disabled for each address that has control/data flag that indicates data.

When the disable data command has not been received, the method moves from step 414 to step 418 to determine if an enable control command has been received. When the enable control command has been received, the method moves to step 420 to set the enabled/disabled flags to enabled for each address that has a control/data flag that indicates control.

Returning again to FIG. 3, to complete the start up, the method moves to step 318 where global control card 124 address local controller 214A, and outputs the enable all command to the active access card 120. The command logic of local controller 214A can process the enable all command by stepping through all of the rows in the binary tables in memories 210A and 212A, and setting each enable/disable flag to enable unless the key is equal to a predefined pattern, such as all the zeros or all ones that are used to represent empty rows.

After the enable all command has been processed, the method moves to step 320 where global control card 124 outputs the enable control command to standby access card 122. The command logic of local controller 214B can process the enable control command by stepping through all of the rows in the binary tables in memories 210B and 212B, and setting each enable/disable flag to enable when the control/data flag is set to control.

During normal operation, memory circuit 210A outputs forwarding information from the routing information column when the key information of a cell matches a key and the associated enable/disable flag is set to enable. FIG. 5 shows a flow chart that illustrates a method of operating memory circuit 210A in accordance with the present invention.

As shown in FIG. 5, the method begins at step 510 where memory circuit 210A receives a series of ATM cells from data network 114. Next, the method moves to step 512 to extract key information, such as the VCI and VPI, from each ATM cell. Following this, the method moves to step 514 to compare the key information from each ATM cell with the keys in the key column of the binary table in memory circuit 210A.

Next, the method moves to step 516 where memory circuit 210A outputs forwarding information for an ATM cell when the key information of the ATM cell matches a key and an associated enable/disable flag is set to enable. When the key information of a cell does not match a key, or the enable/disable flag is set to disable, memory circuit 210A outputs nothing. In addition, memory circuit 210B operates the same as memory circuit 210A. Further, routing circuits 132A, 132B, 136A, and 136B operate the same in system 200 as in system 100.

When active access card 120 fails, global control card 124 detects the condition, and proceeds to shift control over to standby access card 122, which now becomes the new active access card. FIG. 6 shows a flow chart that illustrates a method of operating global control card 124 when a failure has occurred in accordance with the present invention.

As shown in FIG. 6, the method begins at step 610 where global control card 124 detects a failure condition. When a failure condition has been detected, the method moves to step 612 where global control card 124 outputs a disable data command to access card 120. The command logic of local controller 214A can process the disable data command by stepping through all of the rows in the binary tables of access card 120, and setting each enable/disable flag to disable for each address that has a control/data flag set to data.

Following this, the method moves to step 614 where global control card 124 outputs the enable all command to the new active access card 122. The command logic of local controller 214B can process the enable all command by stepping through all of the rows in the binary tables of new active access card 122, and setting each enable/disable flag to enable unless the key is equal to a predefined pattern such as all zeros or all ones.

One of the advantages of the present invention is that communication system 200 is substantially faster than communication system 100 in switching over after the failure of active access card 120. In the present invention, global control card 124 need only output two commands when active access card 120 fails, the disable data command sent to access card 120, and the enable all command sent to access card 122.

In addition, the steps required to implement these two commands can be implemented in dedicated command logic. As a result, the status of the binary tables in the access cards 120 and 122 can be changed very quickly. The present invention is substantially faster than the prior art approach of searching the binary tables on card 120 to find each key to find the physical address to then write an invalid data address, followed by searching the binary tables on card 122 to find each key to find the physical address to then write a valid address.

Thus, by setting the disable flags on the rows with data routes, the binary tables on the standby access card can be loaded with valid data routes while still preventing the binary tables from outputting information to the routing circuits. As a result, global control card 124 can communicate with both access cards 120 and 122, while at the same time preventing access cards 120 and 122 from competing with each other. As long as active access card 120 is functioning properly, only active access card 120 forwards data cells.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A communication system comprising:
an active input circuit having:
an active input memory circuit that has a plurality of addresses, the plurality of addresses having an associated plurality of keys and forwarding information, the active input memory circuit receiving a plurality of cells, extracting key information from each cell, and comparing the key information from each cell with the keys, the active input memory circuit outputting forwarding information for a cell when the key information of the cell matches a key; and
an active input routing circuit that is connected to the active input memory circuit, the active input routing circuit receiving the plurality of cells, and forwarding information from the active input memory circuit for a number of the cells, the active input routing circuit transmitting an input cell onto a bus in response to forwarding information for the input cell.

2. The communication system of claim 1 wherein:
the plurality of addresses have an associated plurality of enabled/disabled flags;
the active input memory circuit outputs forwarding information when the key information of the cell matches a key and an associated enable/disable flag is enabled.

3. The communication system of claim 2 and further comprising a command processing circuit connected to the input active memory, the command processing circuit receiving an enable all command and setting the enabled/disabled flag to enabled for each address unless the address has a key that matches a predetermined pattern.

4. The communication system of claim 3 wherein:
the plurality of addresses have an associated plurality of control/data flags; and
the command processing circuit receives a disable data command and sets the enabled/disabled flag to disabled for each address that has a control/data flag set to data.

5. The communication system of claim 4 wherein the command processing circuit receives an enable control command and sets the enabled/disabled flag to enabled for each address that has control/data flag set to control.

6. The communication system of claim 5 wherein the command processing circuit is combinational logic.

7. The communication system of claim 2 and further comprising:
a standby input circuit connected to the active input circuit, the standby input circuit having:
a standby input memory circuit that has a plurality of addresses that have an associated plurality of keys, forwarding information, and enabled/disabled flags, the standby input memory circuit receiving the plurality of cells, extracting key information from each cell, and comparing the key information from each cell with the keys, the standby input memory circuit outputting forwarding information for a received cell when the key information of the received cell matches a key and an associated enable/disable flag is enabled; and
a standby input routing circuit that is connected to the standby input memory circuit, the standby input routing circuit receiving the cells, and forwarding information for a number of the cells from the standby input memory circuit, the standby input routing circuit transmitting a received input cell onto the bus in response to forwarding information for the received input cell.

8. The communications system of claim 7 wherein the forwarding information associated with the keys in the active input memory circuit and the standby input memory circuit include valid entries unless a key matches a predetermined pattern.

9. The communication system of claim 8 wherein:
the plurality of addresses in the active input memory circuit include a plurality of control/data flags; and
the plurality of addresses in the standby input memory include a plurality of control/data flags.

10. The communication system of claim 9 wherein:
the plurality of addresses in the active input memory circuit that have control/data flags that indicate data are enabled; and
the plurality of addresses in the standby input memory circuit that have control/data flags that indicate data are disabled.

11. The communication system of claim 10 wherein:
the plurality of addresses in the active input memory circuit that have keys and control/data flags that indicate control are enabled; and
the plurality of addresses in the standby input memory circuit that have keys and control/data flags that indicate control are enabled.

12. A method of operating a circuit that has a plurality of addresses that have an associated plurality of keys and forwarding information, the method comprising the steps of:
receiving a plurality of cells;
extracting key information from each cell;
comparing the key information from each cell with the keys, and
outputting forwarding information for an input cell when the key information of the input cell matches a key.

13. The method of claim 12 wherein:
the plurality of addresses also have an associated plurality of enabled/disabled flags; and
the outputting step outputs forwarding information when the key information of the input cell matches a key and an associated enable/disable flag is enabled.

14. The method of claim 13 and further comprising the steps of:
receiving an enable all command; and
setting the enabled/disabled flags to enabled for each address unless the address has a key that matches a predetermined pattern.

15. The method of claim 14 wherein:
the plurality of addresses include an associated plurality of control/data flags, and further comprising the steps of:
receiving a disable data command; and
setting the enabled/disabled flags to disabled for each address that has control/data flag that indicates data.

16. The method of claim 15 and further comprising the steps of:
receiving an enable control command; and
setting the enabled/disabled flags to enabled for each address that has a control/data flag that indicates control.

17. The method of claim 16 wherein the circuit includes a memory circuit and a local control circuit.

18. A method of operating a circuit that has a plurality of addresses that have an associated plurality of keys, forwarding information, control/data flags, and enable/disable flags, the method comprising the steps of:
determining whether an enable all command has been received; and
when the enable all command has been received, setting the enabled/disabled flags to enabled for each address unless the address has a key that matches a predetermined pattern.

19. A method of operating a circuit connected to first and second local controllers via a bus, the method comprising the steps of:
addressing the first local controller over the bus and writing a plurality of control routes to the first local controller;
addressing the second local controller over the bus and writing a plurality of control routes to the second local controller;
addressing the first local controller over the bus, and writing a plurality of data routes with valid routing information to the first local controller;
addressing the second local controller over the bus, and writing a plurality of data routes with valid routing information to the second local controller;
addressing the first local controller over the bus and writing an enable all command to the first local controller; and
addressing the second local controller over the bus and writing an enable control command to the second local controller.

20. A method of operating a circuit connected to first and second local controllers via a bus, the method comprising the steps of:
detecting a failure condition;
when a failure condition has been detected, outputting a disable data command to the first local controller; and
outputting an enable all command to the second local controller.
